(19) United States
(12) Patent Application Publication
(10) Pub. No.: US 2010/0106525 A1
(43) Pub. Date: Apr. 29, 2010

(54) SYSTEM AND METHOD FOR REMOTE HEALTH MANAGEMENT

(75) Inventors: Jeffrey A. Wolf, Miami Beach, FL (US); Don Rosen, Staten Island, NY (US); Arnold W. Pittler, Ft. Lauderdale, FL (US)

Correspondence Address: LAW OFFICE OF DONALD D. MONDUL, 3060 Bonsai Drive, Plano, TX, 75093, US

(73) Assignee: GENERATIONONE, INC., A CORPORATION OF DELAWARE, Miami Beach, FL (US)

(21) Appl. No.: 12/557,238

(22) Filed: Sep. 10, 2009

Related U.S. Application Data
(60) Provisional application No. 61/107,950, filed on Oct. 23, 2008.
(60) Provisional application No. 61/108,865, filed on Oct. 27, 2008.

(51) Int. Cl. G06Q 50/00

(52) U.S. Cl. 705/3; 705/2

(57) ABSTRACT

A system for remote health management includes: (a) a communicating management unit; (b) a decision support unit; (c) at least one communication network coupled with at least one of the communicating management unit and the decision support unit; (d) at least one care rendering unit coupled with at least one of the communicating management unit and the decision support unit via a communication network; (e) a plurality of remote communicating units coupled with at least one care rendering entity via a communication network and at least one of the communicating management unit and the decision support unit; at least one of the communicating management unit and the decision support unit participating in selected communications among a selected care rendering entity and a remote communicating unit to present a recommended result based upon a predetermined set of parametric values to effect the remote health management.

This application claims benefit of prior filed copending Provisional Patent Application Ser. No. 61/107,950, filed Oct. 23, 2008; and copending Provisional Patent Application Ser. No. 61/108,865, filed Oct. 27, 2008.

### FIELD OF THE INVENTION

The present invention is directed to managed health care, and especially to mobile collaborative remotely managed health care.

### BACKGROUND OF THE INVENTION

Health care providers and others have long known that preventive health care can reduce costs and improve effectiveness of care. However, arranging for sufficiently close monitoring of patients by health care providers has heretofore been expensive, even prohibitively expensive for widespread implementation of a sufficiently closely monitored health care monitoring system.

Developments in communication s technology have improved conveyance of test results from patients to health care providers. Developments in testing methods have provided more reliable, more timely and more objectively measurable test results. Developments in diagnostic capabilities have improved accuracy and timeliness of evaluation of test results to diagnose treatment.

There is a need for a system and method for remote health management that advantageously employs communication, testing and diagnostic capabilities to advantageously effect preventive health care in a timely and cost-effective manner.

### SUMMARY OF THE INVENTION

A system for remote health management includes: (a) a communicating management unit; (b) a decision support unit; (c) at least one communication network coupled with at least one of the communicating management unit and the decision support unit; (d) at least one care rendering unit coupled with at least one of the communicating management unit and the decision support unit via a communication network; (e) a plurality of remote communicating units coupled with at least one care rendering entity via a communication network and at least one of the communicating management unit and the decision support unit; at least one of the communicating management unit and the decision support unit participating in selected communications among a selected care rendering entity and a remote communicating unit to present a recommended result based upon a predetermined set of parametric values to effect the remote health management.

A method for remote health management includes: (a) in no particular order: (1) providing a communicating management unit coupled with at least one communication network; at least one care rendering unit being coupled with the at least one communication network; and (2) providing a decision support unit coupled with at least one selected communication network of the at least one communication network; a plurality of remote communicating units being coupled with at least one selected care rendering entity of the at least one care rendering entity via the at least one communication network and at least one of the communicating management unit and the decision support unit; and (b) operating at least one of the communicating management unit and the decision support unit to participate in selected communications among the at least one selected care rendering entity and the plurality of remote communicating units to present at least one recommended result based upon at least one predetermined set of parametric values to effect the remote health management.

It is, therefore, a feature of the present invention to provide a system and method for remote health management that advantageously employs communication, testing and diagnostic capabilities to advantageously effect preventive health care in a timely and cost-effective manner.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating the system of the present invention.

FIG. 2 is a schematic diagram illustrating details of the application server employed in the system of the present invention.

FIG. 3 is a schematic diagram illustrating how a user may interact with the system of the present invention.

FIG. 4 is a schematic diagram illustrating details of the base station illustrated in FIG. 3.

FIG. 5 is a top plan view of a representative mobile unit for use with the present invention.

FIG. 6 is a side view of the representative mobile unit illustrated in FIG. 5.

FIG. 7 is a flow chart illustrating the method of the present invention.

### DETAILED DESCRIPTION OF THE PREFERRED EMBODIMENT

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

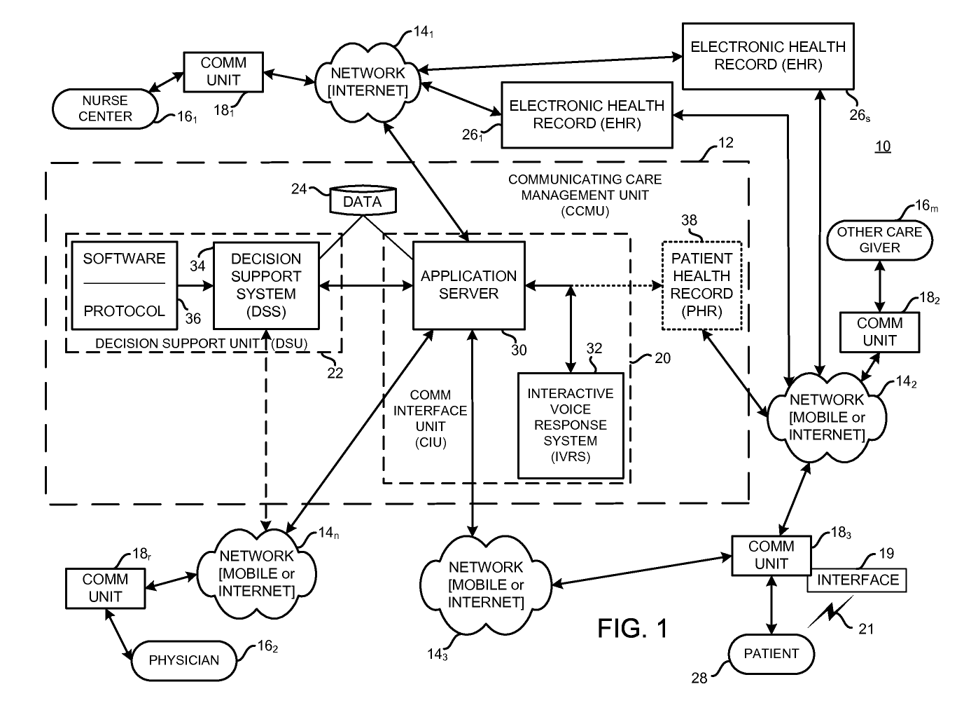

FIG. 1 is a schematic diagram illustrating the system of the present invention. In FIG. 1, a remote health management system 10 configured for effecting mobile collaborative health care with a plurality of patients includes a communicating care management unit 12 and at least one communication network 14₁, 14₂, 14₃, 14ₙ. The indicator “n” is employed to signify that there can be any number of communication networks in remote health management system 10. The inclusion of four communication centers control centers 14₁, 14₂, 14₃, 14ₙ in FIG. 1 is illustrative only and does not constitute any limitation regarding the number of communication networks that may be included in the remote health management system of the present invention. By way of example and not by way of limitation, each respective communication network 14ₙ may be embodied in a private data network, a mobile communication network or another network, such as the Internet. Throughout this description, use of a reference numeral using a generic subscript herein may be taken to mean that any respective member of the plurality of elements having the same reference numeral may be regarded as included in the description. Thus, by way of example and not by way of limitation, referring to communication centers control center 14ₙ in describing FIG. 1 may be taken to mean that any communication centers control center—14₁, 14₂, 14₃, or 14ₙ (FIG. 1)—may be regarded as capable of employment as described.

Remote health management system 10 may also include at least one care rendering unit 16₁, 16₂, 16ₘ. The indicator “m” is employed to signify that there can be any number of care rendering units in remote health management system 10. The inclusion of three care rendering units 16₁, 16₂, 16ₘ in FIG. 1 is illustrative only and does not constitute any limitation regarding the number of care rendering units that may be included in the remote health management system of the present invention. By way of example and not by way of limitation, a respective care rendering unit 16ₘ may be embodied in a nurse center (e.g., care rendering unit 16₁), a physician (e.g., care rendering unit 16₂) or another care giver (e.g., care giving unit 16ₘ). Other care givers may include, by way of example and not by way of limitation, hospice facilities and weight loss clinics.

Remote health management system 10 may further include a plurality of remote communicating units 18₁, 18₂, 18₃, 18ᵣ. The indicator “r” is employed to signify that there can be any number of remote communicating units in remote health management system 10. The inclusion of four remote communicating units 18₁, 18₂, 18₃, 18ᵣ in FIG. 1 is illustrative only and does not constitute any limitation regarding the number of remote communicating units that may be included in the remote health management system of the present invention. By way of example and not by way of limitation, each respective communicating unit 18ᵣ may be embodied in a mobile phone or other wireless device, a computer network interface, or another communicating unit for effecting digital communications between a user and communicating care management unit 12.

Communicating care management unit 12 may include a communication interface unit 20 coupled with a decision support unit 22. Communication interface unit 20 and decision support unit 22 may share a data store 24.

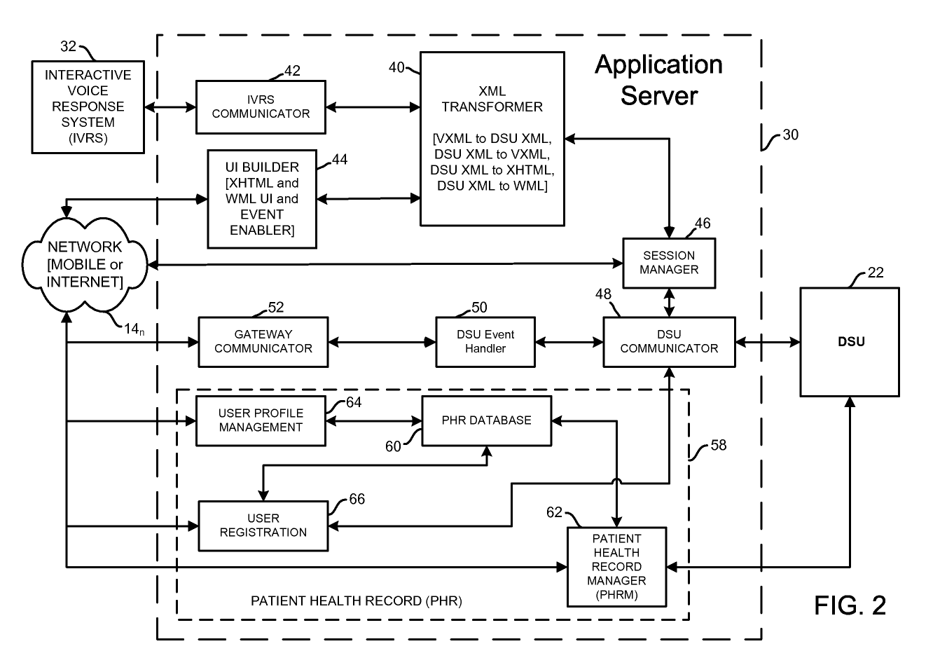

Communication interface unit 20 may include an application server 30 (described in greater detail in connection with FIG. 2) for managing communication operations, and a coupled interactive voice response system 32. Decision support system 22 may include a decision support system 34 supported by a coupled software program or protocol 36.

Communicating care management unit 12 may further include a patient health record 38 for storing patient health information on-line in a digital format.

Selected communication networks 14ₙ may be coupled for sharing information with other on-line electronic health record systems 26₁, 26ₛ. The indicator “s” is employed to signify that there can be any number of on-line electronic health record systems in remote health management system 10. The inclusion of two on-line electronic health record systems 26₁, 26ₛ in FIG. 1 is illustrative only and does not constitute any limitation regarding the number of on-line electronic health record systems that may be included in the remote health management system of the present invention. Examples of on-line health record systems may include, by way of example and not by way of limitation, Google Health® and Microsoft Healthvault®.

Remote health management system 10 permits a user to employ a remote communicating unit 18ᵣ and a communication network 14ₙ to establish communications with communicating care management unit 12 to effect remote health management such as, by way of example and not by way of limitation, mobile collaborative health care. A user may be a care rendering unit 16ₘ or a patient 28. In such a remote health management system 10 a patient 28 or care rendering unit 16ₘ may convey test results, such as a blood sugar reading from a blood sugar measuring device, via a remote communicating unit 18ᵣ (such as a mobile phone unit) and a communication network 14ₙ (such as a mobile network) to communication management care unit 12 via application server 30 or decision support system 34. By way of example and not by way of limitation, patient 28 may wirelessly communicate (indicated at 21 in FIG. 1) with remote communicating unit 18₃ via an interface unit 19 to effect the desired connection with remote health management system 10. Interface unit 19 may be configured to provide specialized wireless connections directly with patient monitoring devices (not shown in detail in FIG. 1) such as, by way of example and not by way of limitation, blood testing, glucose testing, blood pressure testing, weight measuring or other testing or measuring apparatuses. Specialized wireless connections may include, by way of further example and not by way of limitation, Bluetooth wireless connections. The diagnostic information (i.e., blood sugar reading) may be evaluated using software or protocol 36 in cooperation with decision support system 34 and a recommendation may be provided to the patient via the mobile network and mobile communication unit either directly by decision support system 34 or in cooperation with application server 30. The recommendation may be in response to a voice reporting of the blood sugar reading (or other information) conveyed in a voice message generated by interactive voice response system 32 in cooperation with application server 30. An interactive voice response system may be an automated telephone information system that speaks to a caller with a combination of fixed voice menus and data extracted from databases, such as patient health record 38. Blood sugar readings (or other information) may be conveyed by a patient 28 or care rendering unit 16ₘ via a cable hookup to interface unit 19 at the sender's location. Alternatively, as mentioned earlier herein, information may be conveyed to interface unit 19 at the sender's location via a wireless connection 21 such as, by way of example and not by way of limitation, a Bluetooth link.

Information may originate from a care rendering unit 16ₘ to remind patient 28 to take prescribed medication, to inquire whether patient 28 has made a particular appointment or to inquire as to another aspect of patient 28 health or other circumstances.

Test results or recommendations may be entered into patient health record 38. Information stored in patient health record 38 may be used by application server 30 or decision support unit 22 in formulating later inquiries to patient 28 regarding prescribed actions originating from a care rendering unit 16ₘ. Such two-way communication and such two-way use of information—for reporting and for managing health of a patient—among care rendering units 16ₘ and patient 28 in cooperation with communicating care management unit 12 establishes a mobile collaborative health care system having significant value in affording preventive health care for patient 28. Patient health record 38 may participate in such collaborative health care, and electronic health records 26ₛ may as well be included in such a system.

FIG. 2 is a schematic diagram illustrating details of the application server employed in the system of the present invention. In FIG. 2, application server 30 is illustrated as coupled with a decision support unit (DSU) 22, an interactive voice response system (IVRS) 32 and a communication network 14ₙ, generally as described in connection with FIG. 1.

Application 30 may include a translation unit 40 embodied, by way of example and not by way of limitation in an XML transformer unit. Translation unit 40 effects translation among a variety of information or communication formats that may be conveyed within remote health management system 10 (FIG. 1). By way of further example and not by way of limitation, translation unit 40 may effect translation among the following information or communication formats:

XML (eXtensible Markup Language)—a formal recommendation from the World Wide Web Consortium (W3C). It is a flexible, human readable way of describing structured data. XML is a way to create common information formats and share both the format and the data on the World Wide Web, intranets and elsewhere. XML can be used by any individual or group of individuals or companies that wants to share information in a consistent way. XML is similar to the Hypertext Markup Language (HTML). Both XML and HTML contain markup symbols to describe the contents of a page or file. HTML, however, describes the content of a Web page (mainly text and graphic images) only in terms of how it is to be displayed and interacted with. XML describes the content in terms of what data is being described. XML is “extensible” because, unlike HTML, the markup symbols are unlimited and self-defining.

VXML (Voice Extensible Markup Language, or VoiceXML)—a technology that allows a user to interact with the Internet or another network through voice-recognition technology. Instead of a traditional browser that relies on a combination of HTML and keyboard and mouse, VXML relies on a voice browser or a telephone. Using VXML, a user may interact with a voice browser by listening to an audio output that is either pre-recorded or computer-synthesized and submitting an audio input through the user's natural speaking voice or through a keypad, such as a telephone.

XHTML (Extensible Hypertext Markup Language)—a reformulation of HTML 4.0 as an application of the eXtensible Markup Language (XML). The term extensible indicates that the markup language can be used to invent a particular set of markup symbols for a particular purpose. The result is XHTML may be used as an application of XML for “expressing” Web pages.

WML (Wireless Markup Language)—based on XML, WML is a content format for devices that implement the Wireless Application Protocol (WAP) specification, such as mobile phones. WML preceded the use of other markup languages now used with WAP, such as XHTML. WML documents are XML documents that validate against the WML DTD (Document Type Definition).

Translation unit 40 may be coupled with an IVRS communicator unit 42 to aid in effecting communications with IVRS 32. Translation unit 40 may be coupled with communication network 14ₙ via a user interface (UI) builder unit 44 to aid in effecting communications with communication network 14ₙ. UI Builder unit 44 may aid translation unit 40 in carrying out some translation operations.

Translation unit 40 may also be coupled with a session manager unit 46. Session manager unit 46 may be configured to manage session scheduling for events addressed by translation unit 40 or IVRS 32. Session manager unit 46 may be coupled with communication network 14ₙ to aid scheduling access among communication network 14ₙ, translation unit 40 and IVRS 32. Session manager unit 46 may be coupled with decision support unit (DSU) 22 via a DSU communicator unit 48 to aid scheduling access among DSU 22, translation unit 40 and IVRS 32.

DSU communicator unit 48 may also be coupled with communication network 14n via a DSU event handler unit 50 and a gateway communicator unit 52 to manage communications by DSU 22 with other entities in remote health management system 10 (FIG. 1) such as, by way of example and not by way of limitation, care rendering units 16ₘ and patient 28.

The embodiment of application server 30 illustrated in FIG. 2 includes an integral patient health record 58 contained within application server 30 in contrast with a separately configured and coupled patient health record 38, as illustrated in FIG. 1. Integral patient health record 58 includes a patient health record data base unit 60 for storing information relating to patient health records. Patient health record data base unit 60 is coupled with DSU 22 via a patient health record manager unit 62 to coordinate inputs to patient health record data base unit 60 from DSU 22. Patient health record data base unit 60 is also coupled with communication network 14ₙ via patient health record manager unit 62 to coordinate inputs to patient health record data base unit 60 from communication network 14ₙ. Patient health record data base unit 60 is coupled with communication network 14ₙ via a user profile management unit 64 to aid in communicating with users (e.g., care rendering units 16ₘ or patient 28) via communication network 14ₙ. A user registration unit 66 is coupled among communication network 14ₙ, patient health record data base unit 60 and DSU communicator unit 48 to effect registration of a user appropriately so as to provide data entries identified with respect to the user after registration for use within remote health management system 10 (FIG. 1).

Throughout this description, use of a reference numeral using a generic subscript herein may be taken to mean that any respective member of the plurality of elements having the same reference numeral may be regarded as included in the description. Thus, by way of example and not by way of limitation, referring to communication network 14ₙ in describing FIG. 2 may be taken to mean that any communication network—14₁, 14₂, 14₃, or 14ₙ (FIG. 1)—may be regarded as capable of employment as described.

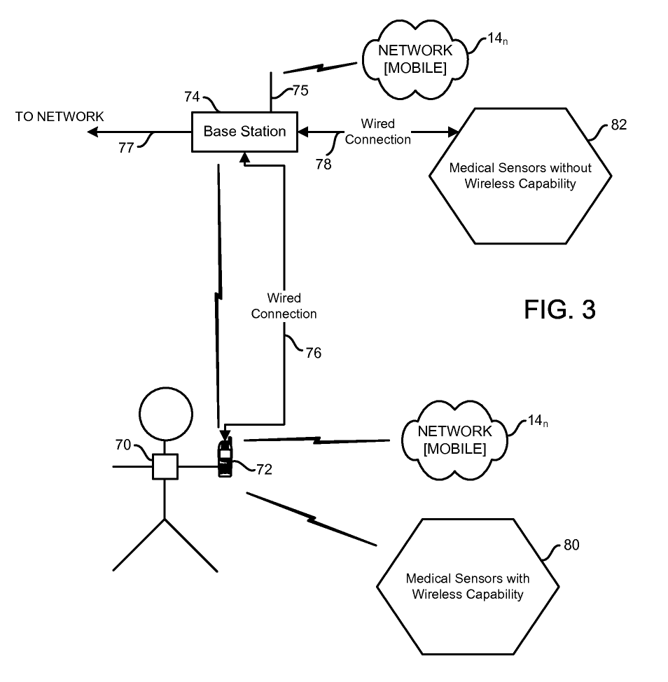

FIG. 3 is a schematic diagram illustrating how a user may interact with the system of the present invention. In FIG. 3, a user 70 may communicate with a network 14n using a mobile phone unit 72. Mobile phone unit 72 may be linked wirelessly with a base station 74. Alternately mobile phone unit 72 may be embodied in a cordless phone unit (not separately indicated in FIG. 3) having a lesser effective communicating range than a mobile phone unit such as a cellular phone, but still wirelessly coupled with base station 74.

Yet another embodiment provides a wired link or connection 76 between mobile phone unit 72 and base station 74. In a preferred embodiment, mobile phone unit 72 carries on all communications between user 70 and remote health management system 10 (FIG. 1). Medical sensors 80 having a wireless linking capability may link wirelessly with mobile phone unit 72 for conveyance of information generated by medical sensors 80 to remote health management system 10 via communication network 14ₙ. Medical sensors 82 not having a wireless linking capability may be linked with base station 74 via a wired link or connection 78 for conveyance of information generated by medical sensors 82. Information thus obtained by base station 74 may be conveyed to mobile phone unit 72 wirelessly or via wired connection 76 for relay to remote health management system 10 via communication network 14ₙ.

Base station 74 may, in an alternate embodiment, have a capability for wireless linking with a communication network 14ₙ, or base station 74 may have a land line connection with another network 14ₙ (not shown in FIG. 3) such as the Internet.

In any of the alternate embodiments described above, base station 74 may include additional capabilities complementary to operation of remote health management system 10 (FIG. 1). Base station 74 may provide an intelligent charging function for a mobile phone unit 77, providing intelligent indications of charging status such as via light indicators or voice alerts. Base station 74 may provide other alert indicators—visual or audio—relating to events such as, by way of example and not by way of limitation, occasions for taking medication, occasions for calling one's physician, occasions for checking a medical condition such as blood sugar or blood pressure or another occasions. Base station 74 may be responsive to signals received from mobile phone unit 72 for effecting the alerting or other functioning of base station 74.

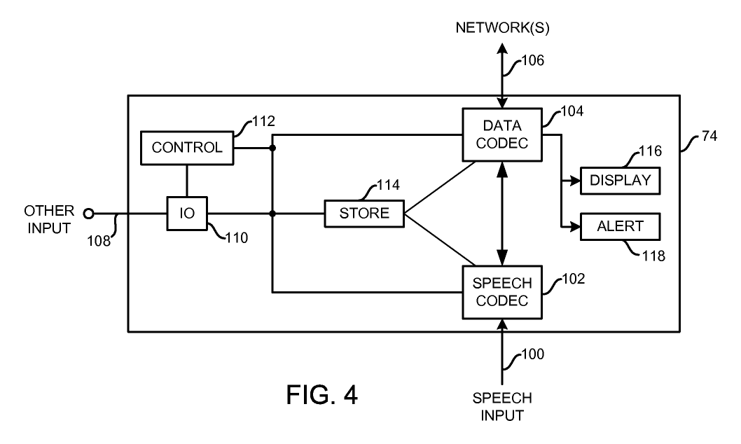

FIG. 4 is a schematic diagram illustrating details of the base station illustrated in FIG. 3. In FIG. 4, base station 74 may include a speech input locus 100 to a speech CODEC (Coder-Decoder) unit 102. Speech CODEC 102 converts speech received at speech input locus 102 to a digital representation of the received speech and provides that digital representation to a data CODEC 104. Data CODEC 104 treats the received digital signal as required to present an appropriately coded signal for transmission via a communication coupling 106 (e.g., a land line or a wireless connection) to a network (e.g., communication network 14ₙ; FIG. 1). Data CODEC 104 may employ information stored in a data store 114 in formulating the coded signal for transmission via coupling 106. Another input locus 108 receives other than speech signals (e.g., wireless signals or wired connection signals (see FIG. 3) to an input-output (IO) unit 110 and thence to either data store 114 or data CODEC 104 as appropriate for proper operation of base station 74. A control unit 112 is coupled with speech CODEC 102, data CODEC 104, IO unit 110 and data store 114 to effect proper operation of base station 74.

Control unit 112, data store 114 and data CODEC 104 may cooperate to defect operation of visual or audio displays and alerts operating display unit 116 or alert unit 118 appropriately to effect proper operation of base station 74 in response to input signals received at speech input locus 100 or other input locus 108.

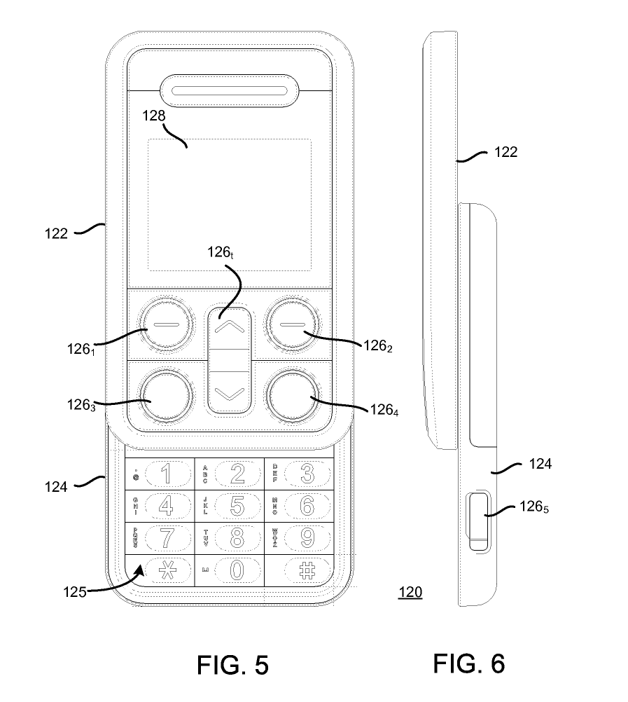

FIG. 5 is a top plan view of a representative mobile unit for use with the present invention. FIG. 6 is a side view of the representative mobile unit illustrated in FIG. 5. Regarding FIGS. 5 and 6 together, a mobile phone unit 120 includes a phone body 122 slidingly receiving a keypad unit 124. Phone body 122 and keypad unit 124 are coupled to effect cooperative operation in carrying out mobile communications. Phone body 122 and keypad unit 124 are illustrated n FIGS. 5 and 6 in an operational orientation with keypad unit 124 presenting a key matrix 125 exposed for access by a user for effecting data entry using key matrix 125. Keypad unit 124 may be slid into substantial register with phone body 122 to a stowed position presenting a more compact package and protecting keypad unit 124 in while in the stowed position. Mobile phone unit 120 has a plurality of actuators or buttons 126₁, 126₂, 126₃, 126₄, 126₅, 126ₜ. The indicator “t” is employed to signify that there can be any number of actuators or buttons in mobile phone unit 120. The inclusion of six actuators or buttons 126₁, 126₂, 126₃, 126₄, 126₅, 126ₜ in FIGS. 5 and 6 is illustrative only and does not constitute any limitation regarding the number of actuators or buttons that may be included in the mobile phone unit 120 of the present invention. Actuators 126ₜ may be employed by a user for navigate functions of mobile phone unit 120, including entry of medical information and retrieval of medical information such as, by way of example and not by way of limitation, reminders, alerts, queries and other information sent or received using mobile phone unit 120. Mobile phone unit 120 also includes a display unit 128 for effecting communication s within remote health management system 10 (FIG. 1).

Mobile phone unit 120 may operate using a common carrier communication network 14ₙ, or may operate using a proprietary network independent of common carrier networks. Operators of remote health management systems of the sort disclosed herein may advantageously tailor service offerings that provide incentives such as, by way of example and not by way of limitation, free minutes, fee text messages and other mobile network consumer offerings. Such incentives may be provided as features of health plans, employers, or other organizations as a way to encourage adoption of a remote health management system to encourage consumer participation in disease management and wellness programs.

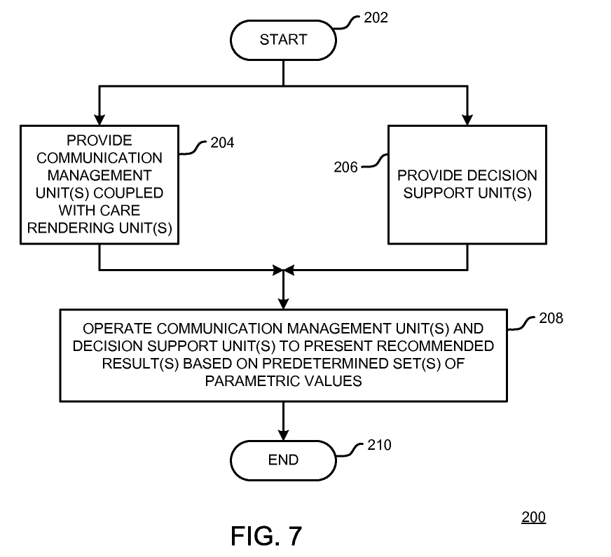

FIG. 7 is a flow chart illustrating the method of the present invention. In FIG. 7, a method 200 for remote health management begins at a START locus 202. Method 200 continues with, in no particular order: (1) providing a communicating management unit coupled with at least one communication network, at least one care rendering unit being coupled with the at least one communication network, as indicated by a block 204; and (2) providing a decision support unit coupled with at least one selected communication network of the at least one communication network, a plurality of remote communicating units being coupled with at least one selected care rendering entity of the at least one care rendering entity via the at least one communication network and at least one of the communicating management unit and the decision support unit, as indicated by a block 206. Method 200 continues with operating at least one of the communicating management unit and the decision support unit to participate in selected communications among the at least one selected care rendering entity and the plurality of remote communicating units to present at least one recommended result based upon at least one predetermined set of parametric values to effect the remote health management, as indicated by a block 208. Method 200 terminates at an END locus 210.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

We claim:

1. A system for effecting mobile collaborative health care with a plurality of patients; the system comprising:
(a) a communicating care management unit; said communicating care management unit including a decision support unit and a communication interface unit;
(b) at least one communication network coupled with said communicating care management unit;
(c) at least one care rendering entity communicatingly coupled with said communicating care management unit via said at least one communication network; and
(d) a plurality of remote communicating units communicatingly linking with at least one selected care rendering entity of said at least one care rendering entity via said at least one communication network and said communicating care management unit; at least one of said communication interface unit and said decision support unit participating in selected communications among said at least one selected care rendering entity and said plurality of remote communicating units to present at least one recommended result based upon at least one predetermined set of parametric values to effect said mobile collaborative health care.

2. A system for effecting mobile collaborative health care with a plurality of patients as recited in claim 1 wherein said plurality of remote communicating units and said at least one care rendering entity effect communications in a plurality of information formats, and wherein said communication interface unit effects translation among said plurality of information formats to effect said communicatingly linking.

3. A system for effecting mobile collaborative health care with a plurality of patients as recited in claim 1 wherein said plurality of remote communicating units includes a plurality of mobile communicating units.

4. A system for effecting mobile collaborative health care with a plurality of patients as recited in claim 1 wherein said communicating care management unit further includes an electronic patent health record unit.

5. A system for effecting mobile collaborative health care with a plurality of patients as recited in claim 1 wherein said at least one communication network includes at least one of a mobile communication network and the Internet.

6. A system for effecting mobile collaborative health care with a plurality of patients as recited in claim 2 wherein said plurality of remote communicating units includes a plurality of mobile communicating units, and wherein said at least one communication network includes at least one of a mobile communication network and the Internet.

7. A system for effecting mobile collaborative health care with a plurality of patients as recited in claim 6 wherein said communicating care management unit further includes an electronic patent health record unit.

8. A system for remote health management comprising:
(a) a communicating management unit;
(b) a decision support unit;
(c) at least one communication network coupled with at least one of said communicating management unit and said decision support unit;
(d) at least one care rendering unit coupled with at least one of said communicating management unit and said decision support unit via said at least one communication network; and
(e) a plurality of remote communicating units coupled with at least one selected care rendering entity of said at least one care rendering entity via said at least one communication network and at least one of said communicating management unit and said decision support unit; at least one of said communicating management unit and said decision support unit participating in selected communications among said at least one selected care rendering entity and said plurality of remote communicating units to present at least one recommended result based upon at least one predetermined set of parametric values to effect said remote health management.

9. A system for remote health management as recited in claim 8 wherein said plurality of remote communicating units and said at least one care rendering entity effect communications in a plurality of information formats, and wherein said communication interface unit effects translation among said plurality of information formats to effect said communicatingly linking.

10. A system for remote health management as recited in claim 8 wherein said plurality of remote communicating units includes a plurality of mobile communicating units.

11. A system for remote health management as recited in claim 8 wherein said communicating care management unit further includes an electronic patent health record unit.

12. A system for remote health management as recited in claim 8 wherein said at least one communication network includes at least one of a mobile communication network and the Internet.

13. A system for remote health management as recited in claim 9 wherein said plurality of remote communicating units includes a plurality of mobile communicating units, and wherein said at least one communication network includes at least one of a mobile communication network and the Internet.

14. A system for remote health management as recited in claim 13 wherein said communicating care management unit further includes an electronic patent health record unit.

15. A method for remote health management; the method comprising:
(a) in no particular order:
(1) providing a communicating management unit coupled with at least one communication network; at least one care rendering unit being coupled with said at least one communication network; and
(2) providing a decision support unit coupled with at least one selected communication network of said at least one communication network; a plurality of remote communicating units being coupled with at least one selected care rendering entity of said at least one care rendering entity via said at least one communication network and at least one of said communicating management unit and said decision support unit; and
(b) operating at least one of said communicating management unit and said decision support unit to participate in selected communications among said at least one selected care rendering entity and said plurality of remote communicating units to present at least one recommended result based upon at least one predetermined set of parametric values to effect said remote health management.

16. A method for remote health management as recited in claim 15 wherein said plurality of remote communicating units and said at least one care rendering entity effect communications in a plurality of information formats, and wherein said communication interface unit effects translation among said plurality of information formats to effect said communicatingly linking.

17. A method for remote health management as recited in claim 15 wherein said plurality of remote communicating units includes a plurality of mobile communicating units.

18. A method for remote health management as recited in claim 15 wherein said communicating care management unit further includes an electronic patent health record unit.

19. A method for remote health management as recited in claim 15 wherein said at least one communication network includes at least one of a mobile communication network and the Internet.

20. A system for remote health management as recited in claim 16 wherein said plurality of remote communicating units includes a plurality of mobile communicating units, and wherein said at least one communication network includes at least one of a mobile communication network and the Internet.
